(19) United States
(12) Patent Application Publication
(10) Pub. No.: US 2021/0234198 A1
(43) Pub. Date: Jul. 29, 2021

(54) ELECTROLYTE FOR HIGH-ENERGY DENSITY, GRAPHITE-CONTAINING BATTERY

(71) Applicant: GM GLOBAL TECHNOLOGY OPERATIONS LLC, Detroit, MI (US)

(72) Inventors: Meinan HE, Madison Heights, MI (US); Mei Cai, Bloomfield Hills, MI (US); Li Yang, Troy, MI (US); Mary E. Fortier, Warren, MI (US); Kely Markley, Hamtramck, MI (US)

(73) Assignee: GM GLOBAL TECHNOLOGY OPERATIONS LLC, Detroit, MI (US)

(21) Appl. No.: 16/776,163

(22) Filed: Jan. 29, 2020

(51) Int. Cl. H01M 10/0567; H01M 10/0569; H01M 4/583; H01M 10/0525

(52) U.S. Cl. CPC H01M 10/0567; H01M 10/0569; H01M 2300/0028; H01M 10/0525; H01M 4/583

(57) ABSTRACT

The present disclosure provides an electrolyte system for an electrode having a loading density of greater than or equal to about 4.0 mAh/cm². The electrolyte system may include greater than or equal to about 1.0 M to less than or equal to about 1.5 M of lithium fluorosulfonylimide (LiN(FSO₂)₂) (LiFSI); less than or equal to about 0.5 M of lithium hexafluorophosphate (LiPF₆); and one or more solvents comprising ethylene carbonate (EC), where the electrolyte includes less than or equal to about 30 wt. % of ethylene carbonate (EC). The electrolyte system may also include one or more electrolyte additives selected from corrosion-resistant additives, formation additives, and stabilizer additives. The formation additives and/or stabilizer additive may assist in the formation and maintenance of a solid electrolyte interface layer on one or more surfaces of the graphite-containing electrode.

### INTRODUCTION

This section provides background information related to the present disclosure which is not necessarily prior art.

The present disclosure relates to electrolytes for use in lithium-ion electrochemical cells, for example, high-energy density lithium-ion batteries, and in particular, graphite-containing lithium-ion batteries.

Advanced energy storage devices and systems are in demand to satisfy energy and/or power requirements for a variety of products, including automotive products such as start-stop systems (e.g., 12V start-stop systems), battery-assisted systems, Hybrid Electric Vehicles (“HEVs”), and Electric Vehicles (“EVs”). Typical lithium-ion and lithium-sulfur batteries include at least two electrodes and an electrolyte and/or separator. One of the two electrodes includes a positive electroactive material and serves as a positive electrode or cathode, and the other electrode includes a negative electroactive material and serves as a negative electrode or anode. Each of the electrodes is connected to a current collector (typically a metal, such as copper for the negative electrode and aluminum for the positive electrode). A separator and/or electrolyte may be disposed between the negative and positive electrodes. The electrolyte is suitable for conducting lithium ions between the electrodes and, like the two electrodes, may be in various instances solid and/or liquid form and/or a hybrid thereof. In instances of solid-state batteries, which include solid-state electrodes and a solid-state electrolyte, the solid-state electrolyte may physically separate the electrodes so that a distinct separator is not required.

Electrolytes for lithium ion, lithium metal, and lithium sulfur batteries often include a conductive salt solubilized in an organic solvent. Example solvents include, for example, cyclic carbonates, such as ethylene carbonate (EC) and linear carbonates (such as ethyl methyl carbonate (EMC)). Example conductive salts include, for example, lithium tetrafluoroborate (LiBF₄) and/or lithium hexafluorophosphate (LiPF₆). Lithium hexafluorophosphate (LiPF₆), a coordination compound of F⁻ and strong Lewis acid (PF₅), may in certain instances react with protons present in the electrochemical cell, for example via a hydrolysis reaction, to form or generate one or more of hydrogen fluoride (HF), lithium fluoride (LiF), and phosphoric acid (H₃PO₄). Such reactions occur more often at elevated temperatures, for example from about 40° C. to about 60° C., and in the instance of electrodes having greater loadings (e.g., >4.0 mAh/cm²) and porosities (e.g., >25%).

In certain instances, the generated compound, for example hydrogen fluoride (HF), may react with a positive electroactive material so as to cause, for example, transition metal dissolution. Transition metal dissolution may result in transition metal ions precipitating on the positive electrode and/or migrating to, and in certain aspects, depositing on the negative electrode, so as to cause cathode active material loss, fading capacity, damage to a solid electrolyte interphase layer, and/or blocking of lithium ion intercalation into the negative electrode (e.g., impedance at the anode). Accordingly, it would be desirable to develop improved materials, for example electrolyte materials, and methods of making the same, for an electrochemical cell that can address these challenges.

### SUMMARY

This section provides a general summary of the disclosure, and is not a comprehensive disclosure of its full scope or all of its features.

In various aspects, the present disclosure provides an electrolyte system for a graphite-containing electrode. The electrolyte system includes greater than or equal to about 1.0 M to less than or equal to about 1.5 M of lithium fluorosulfonylimide (LiN(FSO₂)₂) (LiFSI); less than or equal to about 0.5 M of lithium hexafluorophosphate (LiPF₆); and one or more solvents. The one or more solvents may include ethylene carbonate (EC). The electrolyte system may include less than or equal to about 30 wt. % of ethylene carbonate (EC).

In one aspect, the electrolyte system may further include one or more corrosion-resistant additives. The corrosion-resistant additives may be selected from the group consisting of: lithium difluoro(oxalato)borat (LiDFOB), lithium bis(oxalato)boarate (LiBOB), lithium 2-trifluoromethyl-4,5-dicyanoimidazolide (LiTDI), lithium perchlorate (LiClO₄), lithium hexafluorophosphate (LiPF₆), lithium tetrafluoroborate (LiBF₄), and combinations thereof.

In one aspect, the electrolyte system includes greater than or equal to about 1 wt. % to less than or equal to about 5 wt. % of the one or more corrosion-resistant additives.

In one aspect, the electrolyte system may further include one or more formation additives. The one or more formation additives may be selected from the group consisting of: fluoroethylene carbonate (FEC), bis(trifluoroethyl) carbonate (DFEC), trifluoropropylene carbonate (TFPC), vinylene carbonate (VC), ethylene sulfate (DTD), 1,3-propene sultone (PES), 1,3-propane sultone (PS), and combinations thereof. The one or more formation additives assist in the formation of a solid electrolyte interface layer on one or more surfaces of the graphite-containing electrode.

In one aspect, the electrolyte system includes less than or equal to about 10 wt. % of the one or more formation additives.

In one aspect, the electrolyte system further includes one or more stabilizer additives. The one or more stabilizer additives may be selected from the group consisting of: 1,3,2-dioxathiolane 2,2-dioxide, 1,2-oxathiolane 2,2-dioxide, tetrahydrothiophene 1,1-dioxide, and combinations thereof.

In one aspect, the electrolyte system includes less than or equal to about 5 wt. % of the one or more stabilizer additives.

In various other aspects, the present disclosure provides a high-energy density electrochemical cell that cycles lithium ions. The electrochemical cell includes an electrode and an electrolyte. The electrode includes a graphite-containing electroactive material and has a loading density of greater than or equal to about 4.0 mAh/cm². The electrolyte includes greater than or equal to about 1.0 M to less than or equal to about 1.5 M of lithium fluorosulfonylimide (LiN(FSO₂)₂) (LiFSI); less than or equal to about 0.5 M of lithium hexafluorophosphate (LiPF₆); and one or more solvents. The one or more solvents includes ethylene carbonate (EC). The electrolyte system may include less than or equal to about 30 wt. % of ethylene carbonate (EC).

In one aspect, the electrolyte further includes one or more corrosion-resistant additives. The one or more corrosion-resistant additives may be selected from the group consisting of: lithium difluoro(oxalato)borat (LiDFOB), lithium bis(oxalato)boarate (LiBOB), lithium 2-trifluoromethyl-4,5-dicyanoimidazolide (LiTDI), lithium perchlorate (LiClO₄), lithium hexafluorophosphate (LiPF₆), lithium tetrafluoroborate (LiBF₄), and combinations thereof.

In one aspect, the electrolyte includes greater than or equal to about 1 wt. % to less than or equal to about 5 wt. % of the one or more corrosion-resistant additives.

In one aspect, the electrolyte further includes one or more formation additives. The one or more formation additives may be selected from the group consisting of: fluoroethylene carbonate (FEC), bis(trifluoroethyl) carbonate (DFEC), trifluoropropylene carbonate (TFPC), vinylene carbonate (VC), ethylene sulfate (DTD), 1,3-propene sultone (PES), 1,3-propane sultone (PS), and combinations thereof, wherein the one or more formation additives assist in the formation of a solid electrolyte interface layer on one or more surfaces of the graphite-containing electrode.

In one aspect, the electrolyte includes less than or equal to about 10 wt. % of the one or more formation additives.

In one aspect, the electrolyte includes one or more stabilizer additives. The one or more stabilizer additives may be selected from the group consisting of: 1,3,2-dioxathiolane 2,2-dioxide, 1,2-oxathiolane 2,2-dioxide, tetrahydrothiophene 1,1-dioxide, and combinations thereof.

In one aspect, the electrolyte includes less than or equal to about 2 wt. % of the one or more stabilizer additives.

In various other aspects, the present disclosure provides a high-energy density electrochemical cell that cycles lithium ions. The electrochemical cell includes an electrode and an electrolyte. The electrode includes a graphite-containing electroactive material and has a loading density of greater than or equal to about 4.0 mAh/cm². The electrolyte includes greater than or equal to about 1.0 M to less than or equal to about 1.5 M of lithium fluorosulfonylimide (LiN(FSO₂)₂) (LiFSI) and one or more electrolyte additives. The one or more electrolyte additives may be selected from the group consisting of: lithium difluoro(oxalato)borat (LiDFOB), lithium bis(oxalato)boarate (LiBOB), lithium 2-trifluoromethyl-4,5-dicyanoimidazolide (LiTDI), fluoroethylene carbonate (FEC), bis(trifluoroethyl) carbonate (DFEC), trifluoropropylene carbonate (TFPC), vinylene carbonate (VC), ethylene sulfate (DTD), 1,3-propene sultone (PES), 1,3-propane sultone (PS), 1,3,2-dioxathiolane 2,2-dioxide, 1,2-oxathiolane 2,2-dioxide, tetrahydrothiophene 1,1-dioxide, and combinations thereof.

In one aspect, the electrolyte further includes greater than 0 M to less than or equal to about 0.5 M of lithium hexafluorophosphate (LiPF₆) and one or more solvents. The one or more solvents may include ethylene carbonate (EC). The electrolyte system may include less than or equal to about 30 wt. % of ethylene carbonate (EC).

In one aspect, the electrolyte includes greater than or equal to about 1 wt. % to less than or equal to about 5 wt. % of the one or more electrolyte additives selected from the group consisting of: lithium difluoro(oxalato)borat (LiDFOB), lithium bis(oxalato)boarate (LiBOB), lithium 2-trifluoromethyl-4,5-dicyanoimidazolide (LiTDI), lithium perchlorate (LiClO₄), lithium hexafluorophosphate (LiPF₆), lithium tetrafluoroborate (LiBF₄), and combinations thereof.

In one aspect, the electrolyte includes greater than 0 wt. % to less than or equal to about 10 wt. % of the one or more electrolyte additives selected from the group consisting of: fluoroethylene carbonate (FEC), bis(trifluoroethyl) carbonate (DFEC), trifluoropropylene carbonate (TFPC), vinylene carbonate (VC), ethylene sulfate (DTD), 1,3-propene sultone (PES), 1,3-propane sultone (PS), and combinations thereof.

In one aspect, the electrolyte includes greater than 0 wt. % to less than or equal to about 2 wt. % of one or more electrolyte additives selected from the group consisting of: 1,3,2-dioxathiolane 2,2-dioxide, 1,2-oxathiolane 2,2-dioxide, tetrahydrothiophene 1,1-dioxide, and combinations thereof.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an example electrochemical battery that cycles lithium ions;

FIG. 2 is a graphical illustration of the conductivities (mS/cm) of comparable electrochemical cells having different electrolyte systems;

FIG. 3A is a graphical illustration of the voltages (V) of comparable electrochemical cells having different electrolyte systems as a function of capacity (mAh);

FIG. 3B is a graphical illustration of the discharge capacity (mAh) of comparable electrochemical cells having different electrolyte systems as a function of cycle number;

FIG. 3C is a graphical illustration of the electrochemical impedance of comparable electrochemical cells having different electrolyte systems;

FIG. 4 is a graphical illustration of the corrosion effects of comparable electrochemical cells having different electrolyte systems;

FIG. 5 is a graphical illustration of the corrosion effects of comparable electrochemical cells having different electrolyte additives; and

FIG. 6 is a graphical illustration of the capacity (mAh/g) of comparable electrochemical cells having different electrolyte systems as a function of cycle number

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth, such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers, and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

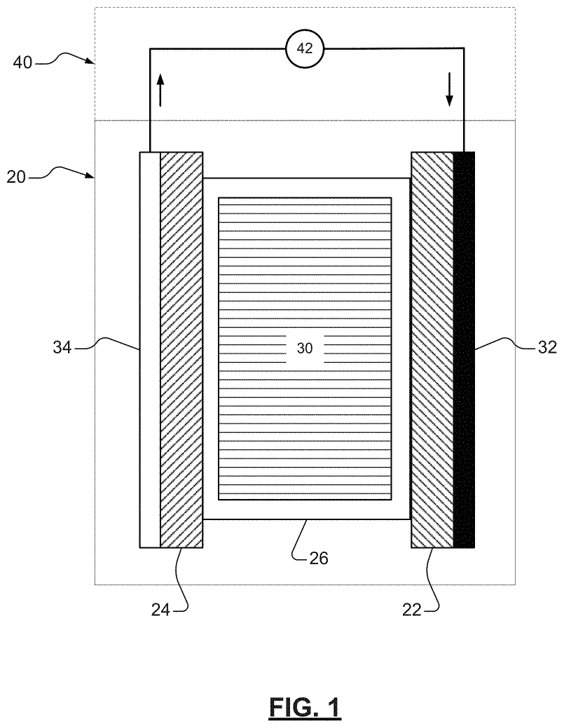

Typical lithium-ion or lithium-sulfur batteries often include a first electrode (such as a positive electrode or cathode) opposing a second electrode (such as a negative electrode or anode) and a separator and/or electrolyte disposed therebetween. Often, in a battery pack, batteries or cells may be electrically connected in a stack or winding configuration to increase overall output. Lithium-ion and lithium-sulfur batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions and, in various aspects, may be in liquid, gel, or solid form. For example, an exemplary and schematic illustration of an electrochemical cell (also referred to as the battery) 20 is shown in FIG. 1. Though the illustrated example includes a single positive electrode (e.g., cathode) 24 and a single negative electrode (e.g., anode) 22, the skilled artisan will recognize that the current teachings apply to various other configurations of electrochemical cells, including those having one or more positive electrodes and one or more negative electrodes, as well as various current collectors with electroactive layers disposed on or adjacent to one or more surfaces thereof.

The battery 20 includes a negative electrode 22, a positive electrode 24, and a separator 26 disposed between the electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24.

A negative electrode current collector 32 may be positioned at or near the negative electrode 22, and a positive electrode current collector 34 may be positioned at or near the positive electrode 24. The negative electrode current collector 32 and the positive electrode current collector 34 respectively collect and move free electrons to and from an external circuit 40. For example, an interruptible external circuit 40 and a load device 42 may connect the negative electrode 22 (through the negative electrode current collector 32) and the positive electrode 24 (through the positive electrode current collector 34). The positive electrode current collector 34 may be a metal foil, metal grid or screen, or expanded metal comprising aluminum or any other appropriate electrically conductive material known to those of skill in the art. The negative electrode current collector 32 may be a metal foil, metal grid or screen, or expanded metal, comprising copper or any other appropriate electrically conductive material known to those of skill in the art.

The battery 20 may generate an electric current during discharge by way of reversible electrochemical reactions that occur when the external circuit 40 is closed (to connect the negative electrode 22 and the positive electrode 24) and the negative electrode 22 contains a relatively greater quantity of lithium than the positive electrode 24. The chemical potential difference between the positive electrode 24 and the negative electrode 22 drives electrons produced by a reaction, for example, the oxidation of intercalated lithium, at the negative electrode 22 through the external circuit 40 towards the positive electrode 24. Lithium ions, which are also produced at the negative electrode 22, are concurrently transferred through the electrolyte 30 contained in the separator 26 towards the positive electrode 24. The electrons flow through the external circuit 40 and the lithium ions migrate across the separator 26 containing the electrolyte 30 to form intercalated lithium at the positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back towards the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid through a wall outlet and a motor vehicle alternator.

In many lithium-ion battery configurations, each of the negative electrode current collector 32, negative electrode 22, separator 26, positive electrode 24, and positive electrode current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30, for example inside their pores, capable of conducting lithium ions between the negative electrode 22 and the positive electrode 24. The electrolyte 30 may be a non-aqueous liquid electrolyte solution that includes one or more lithium salts dissolved in an organic solvent or a mixture of organic solvents. For example, in various aspects, the one or more lithium salts may include lithium fluorosulfonylimide (LiN(FSO₂)₂) (LiFSI) and lithium hexafluorophosphate (LiPF₆). The electrolyte 30 may include, for example, greater than or equal to about 1.0 M to less than or equal to about 1.5 M of lithium fluorosulfonylimide (LiN(FSO₂)₂) (LiFSI), and in certain aspects, greater than or equal to about 0 M to less than or equal to about 0.5 M of lithium hexafluorophosphate (LiPF₆).

In further variations, the one or more lithium salts may further include, for example, one or more of lithium tetrafluoroborate (LiBF₄), lithium triflate (LiCF₃SO₃), lithium bis(trifluoromethanesulfonimide) (LiN(CF₃SO₂)₂), and lithium tetrafluorooxalatophosphate (LiPF₄(C₂O₄)) (LiFOP). In still further variations, the one or more lithium salts may further include, for example, one or more of lithium alkyl fluorophosphate; lithium alkyl fluoroborates; lithium 4,5-dicyano-2-(trifluoromethyl)imidazole; lithium 4,5-dicyano-2-methylimidazole; and trilithium 2,2,2″-tris(trifluoromethyl)benzotris(imidazolate). In other variations, the one or more lithium salts may further include, for example, one or more of Li(CF₂CO₂), LiPF₄(C₂O₄), LiB(C₂O₄)₂, Li(C₂CO₂), LiCH₂SO₃, LiC(CFSO₂)₃, LiBF₂(C₂O₄)₂, and Liz(B₁₂X₁₂₋ₙHₙ) (where X is a halogen, 0≤n≤12).

The organic solvent may comprise, for example, non-aqueous solvent. Illustrative non-aqueous solvents include, for example, ethylene carbonate, dimethyl carbonate, ethyl methyl carbonate, diethyl carbonate, propylene carbonate, fluorinated carbonates, fluoroethylene carbonate, 4-(trifluoromethyl)-1,3-dioxolan-2-one, propylene carbonate, dimethyl carbonate, ethyl methyl carbonate, diethyl carbonate, methyl propyl carbonate, ethyl propyl carbonate, dipropyl carbonate, bis(trifluoroethyl) carbonate, bis(pentafluoropropyl) carbonate, trifluoroethyl methyl carbonate, pentafluoroethyl methyl carbonate, trifluoroethyl ethyl carbonate, heptafluoropropyl ethyl carbonate, hexafluoroisopropyl methyl carbonate, pentafluoroethyl ethyl carbonate, pentafluorobutyl methyl carbonate, pentafluorobutyl ethyl carbonate, dimethoxyethane, triglyme, dimethyl ether, diglyme, tetraglyme, dimethyl ethylene carbonate, ethyl acetate, trifluoroethyl acetate, ethyl methyl sulfone, sulfolane, methyl isopropyl sulfone, butyrolactone, acetonitrile, succinonitrile, methyl 2-cyanoacetate, N,N-dimethyl acetamide, 2,2,2-trifluoro-N,N-dimethylacetamide, methyl dimethylcarbamate, and 2,2,2-trifluoroethyl dimethylcarbamate.

Other solvents that may be used in the electrolyte 30 include, but are not limited to, organic sulfates, esters, cyclic esters, fluorinated esters, nitriles, amides, dinitriles, fluorinated amides, carbamates, fluorinated carbamates, cyanoester compounds, and ionic liquid such as pyrrolidinium-based ionic liquids, piperidinium-based ionic liquids, imidazolium-based ionic liquids, ammonium-based ionic liquids, phosphonium-based ionic liquids, cyclic phosphonium-based ionic liquids, and sulfonium-based ionic liquids. In other variations, the solvents may include one or more ether-based solvents. Illustrative ether-based solvents include, but are not limited to 1,3-dioxolane (“DOL”), dimethoxyethane (“DME”), tetrahydrofuran, di(ethylene glycol) dimethyl ether, tri(ethyleneglycol) dimethyl ether, diglyme (“DGM”), partly silanized ether, tetra(ethylene glycol) dimethyl ether (“TEGDME”), poly(ethylene glycol) dimethyl ether (“PEGDME”), (2,2,2-trifluoroethyl) carbonate (“FEMC”), 1,4-dioxane,1,1,2,2-tetrafluoroethyl-2,2,3,3-tetrafluoropropyl ether, 1,1,2,2-tetrafluoroethyl-2,2,3,3,3-pentafluoropropyl ether, 2,2,2-trisfluoroethyl-1,1,2,3,3,3-hexafluoropropyl ether, ethyl-1,1,2,3,3,3-hexafluoropropyl ether, difluoromethyl-2,2,3,3,3-pentafluoropropyl ether, difluoromethyl-2,2,3,3-tetrafluoropropyl ether, 2-fluoro-1,3-dioxolane, 2,2 difluoro-1,3-dioxolane, 2-trifluoromethyl-1,3-dioxolane, 2,2-bis(trifluoromethyl)-1,3-dioxolane; 4-fluoro-1,3-dioxolane, and 4,5-difluoro-1,3-dioxolane.

As further detailed in the examples below, the presence of lithium fluorosulfonylimide (LiN(FSO₂)₂) (LiFSI) in the electrolyte 30 may increase, in various aspects, the conductivity so as to improve the long-term performance of the battery 20. In certain instances, however, the presence of lithium fluorosulfonylimide (LiN(FSO₂)₂) (LiFSI) in the battery 20 may increase the occurrence and effects of corrosion. For example, aluminum (such as from the positive current collector 34) may have a higher solubility in electrolytes including fluorosulfonylimide (FR⁻), for example by forming Al(FSI)₃. The solubility may be especially enhanced in the instance of higher temperatures and high voltage operation.

In various aspects, reducing the amount of ethylene carbonate (EC) solvent in the electrolyte 30 may reduce corrosion (e.g., aluminum dissolution) in the battery 20. For example, because electrolytes having higher amounts of ethylene carbonate (EC) often have higher concentrations of dissolved Al³⁺ and FR⁻. The electrolyte 30 may include less than or equal to about 30 wt. %, less than or equal to about 20 wt. %, less than or equal to about 10 wt. %, less than or equal to about 5 wt. %, and in certain aspects, optionally less than or equal to about 1 wt. %, of the co-solvent ethylene carbonate (EC). However, as detailed in the below examples, some amount of ethylene carbonate (EC) can be beneficial in inducing formation of and/or maintaining solid electrolyte interface (SEI) protective layers (not shown) on one or more surfaces of the negative electrode 22.

Further still, in various aspects, the electrolyte 30 may include one or more corrosion-resistant additives. For example, the electrolyte 30 may include one or more corrosion-resistant additives selected from the group consisting of: lithium difluoro(oxalato)borat (LiDFOB), lithium bis(oxalato)boarate (LiBOB), lithium 2-trifluoromethyl-4,5-dicyanoimidazolide (LiTDI), lithium perchlorate (LiClO₄), lithium hexafluorophosphate (LiPF₆), lithium tetrafluoroborate (LiBF₄), and combinations thereof. The electrolyte 30 may include greater than or equal to about 1 wt. % to less than or equal to about 5 wt. % of the one or more corrosion-resistant additives.

In various aspects, the electrolyte 30 may induce the passive formation of a solid electrolyte interface (SEI) protective layer on surfaces within the battery 20, for example on one or more surfaces of the negative electrode 22. The solid electrolyte interface (SEI) protective layer may minimize or avoid undesirable further reactions between the electrolyte 30 and the negative electrode 22 and/or further consumption of the electrolyte 30 so as to improve long-term durability and performance of the battery 20. In certain instances, ethylene carbonate (EC) may be used to assist in or induce the formation of a solid electrolyte interface (SEI) protective layer on one or more surfaces of a graphite-containing negative electrode 22.

In various aspects, in addition to or as an alternative to the ethylene carbonate (EC) co-solvent, the electrolyte 30 may include one or more formation additives. The one or more formation additives may assist in the formation of a solid electrolyte interface layer on one or more surfaces of the negative electrode 22 (e.g., graphite-containing electrode). For example, the one or more formation additives may passivate one or more surfaces of the negative electrode 22 so as to form a kinetic barrier. In certain variations, the electrolyte 30 may include one or more formation additives selected from the group consisting of: fluoroethylene carbonate (FEC), bis(trifluoroethyl) carbonate (DFEC), trifluoropropylene carbonate (TFPC), vinylene carbonate (VC), ethylene sulfate (DTD), 1,3-propene sultone (PES), 1,3-propane sultone (PS), and combinations thereof. The electrolyte 30 may include less than or equal to about 10 wt. % of the one or more formation additives.

Similarly, in various aspects, in addition to or as an alternative to the one or more formation additive and/or ethylene carbonate (EC) co-solvent, the electrolyte 30 may include one or more stabilizer additives. The one or more stabilizer additives may help to stabilize the solid electrolyte interface (SEI) protective layer, for example by reducing impedance resulting from the solid electrolyte interface (SEI) protective layer. For example, the electrolyte 30 may include one or more stabilizer additives selected from the group consisting of: 1,3,2-dioxathiolane 2,2-dioxide, 1,2-oxathiolane 2,2-dioxide, tetrahydrothiophene 1,1-dioxide, and combinations thereof. The electrolyte 30 may include less than or equal to about 10 wt. %, less than or equal to about 5 wt. %, and in certain aspects, optionally less than or equal to about 2 wt. % of the one or more stabilizer additives.

In various aspects, the electrolyte 30, for example as a solid-state electrolyte, may serve as both a conductor of lithium ions and a separator, for example separator 26, such that a distinct separator component is not required. In various other aspects, however, the separator 26 may be a microporous polymeric separator including, for example a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous membranes include CELGARD® 2500 (a monolayer polypropylene separator) and CELGARD® 2320 (a trilayer polypropylene/polyethylene/polypropylene separator) available from Celgard LLC. Various other conventionally available polymers and commercial products for forming the separator 26 are contemplated, as well as the many manufacturing methods that may be employed to produce such a microporous polymer separator 26.

When the separator 26 is a microporous polymeric separator, it may be a single layer or a multi-layer laminate, which may be fabricated from either a dry or wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26.

The separator 26 may also comprise other polymers in addition to the polyolefin such as, but not limited to, polyethylene terephthalate (PET), polyvinylidene fluoride (PVdF), polyamide (nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polymethylpentene, polyolefin copolymers, acrylonitrile-butadiene styrene copolymers (ABS), polystyrene copolymers, polymethylmethacrylate (PMMA), polysiloxane polymers (e.g., polydimethylsiloxane (PDMS)), polybenzimidazole (PBI), polybenzoxazole (PBO), polyphenylenes, polyarylene ether ketones, polyperfluorocyclobutanes, polyvinylidene fluoride copolymers (e.g., PVdF—hexafluoropropylene or (PVdF-HFP)), and polyvinylidene fluoride terpolymers, polyvinylfluoride, liquid crystalline polymers (e.g., VECTRAN™ (Hoechst AG, Germany) and ZENITE® (DuPont, Wilmington, Del.)), polyaramides, polyphenylene oxide, cellulosic materials, meso-porous silica, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic coating layer and a heat-resistant material coating. The ceramic coating layer and/or the heat-resistant material coating may be disposed on one or more sides of the separator 26. The material forming the ceramic layer may be selected from the group consisting of: alumina (Al₂O₃), silica (SiO₂), titania (TiO₂), and combinations thereof. The heat-resistant material may be selected from the group consisting of: Nomex, Aramid, and combinations thereof.

Again with renewed reference to FIG. 1, in various aspects, the negative electrode 22 comprises a lithium host material that is capable of functioning as a negative terminal of a lithium-ion battery. For example, the negative electrode 22 may comprise a lithium host material (e.g., negative electroactive material) that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. For example, the negative electrode 22 may include a plurality of electrolyte particles (not shown). The negative electrode 22 may have a porosity of about 25 vol. %.

The negative electrode 22 may include a negative electroactive material that is lithium based comprising, for example, a lithium metal and/or lithium alloy. In other variations, the negative electrode 22 may include a negative electroactive material that is silicon based comprising silicon, for example, a silicon alloy, silicon oxide, or combinations thereof that may be further mixed, in certain instances, with graphite. In still other variations, the negative electrode 22 may include a negative electroactive material that is a carbonaceous anode comprising, for example, one or more negative electroactive materials such as graphite, graphene, and/or carbon nanotubes (CNTs). In still further variations, the negative electrode 22 may comprise one or more lithium-accepting negative electroactive materials, such as lithium titanium oxide (Li₄Ti₅O₁₂), one or more transition metals (such as tin (Sn)), one or more metal oxides (such as vanadium oxide (V₂O₅), tin oxide (SnO), titanium dioxide (TiO₂)), titanium niobium oxide (TiₓNb_{y}O_{z}, where 0≤x≤2, 0≤y≤24, and 0≤z≤64), and one or more metal sulfides (such as ferrous or iron sulfide (FeS)). In various aspects, the negative electrode 22 may have a high loading density. For example, the negative electrode 22 may have a loading density of greater than or equal to about 4.0 mAh/cm².

In various aspects, the negative electroactive material in the negative electrode 22 may be optionally intermingled with one or more electrically conductive materials that provide an electron conductive path and/or at least one polymeric binder material that improves the structural integrity of the negative electrode 22. For example, the negative electroactive material in the negative electrode 22 may be optionally intermingled with binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

For example, the negative electrode 22 may include greater than or equal to about 50 wt. % to less than or equal to about 99 wt. %, and in certain aspects, optionally greater than or equal to about 50 wt. % to less than or equal to about 95 wt. %, of the negative electroactive material; greater than or equal to about 0 wt. % to less than or equal to about 30 wt. %, and in certain aspects, optionally greater than or equal to about 5 wt. % to less than or equal to about 20 wt. %, of one or more electrically conductive materials; and greater than or equal to about 0 wt. % to less than or equal to about 20 wt. %, and in certain aspects, optionally greater than or equal to about 5 wt. % to less than or equal to about 15 wt. %, of one or more binders.

In various aspects, the positive electrode 24 comprises a lithium-based positive electroactive material that is capable of undergoing lithium intercalation and deintercalation, alloying and dealloying, or plating and stripping, while functioning as a positive terminal of the battery 20. In various aspects, the positive electrode 24 may be defined by a plurality of electroactive material particles (not shown). Such positive electroactive material particles may be disposed in one or more layers so as to define the three-dimensional structure of the positive electrode 24. In certain variations, as noted above, the positive electrode 24 may further include the electrolyte 30, for example a plurality of electrolyte particles (not shown). The positive electrode 24 may have a porosity of about 25 vol. %.

In various aspects, the positive electrode 24 may be one of a layered-oxide cathode, a spinel cathode, and a polyanion cathode. For example, layered-oxide cathodes (e.g., rock salt layered oxides) comprise one or more lithium-based positive electroactive materials selected from LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where M is one of Mn, Ni, Co, and Al and 0≤x≤1) (for example LiCoO₂ (LCO), LiNiO₂, LiMnO₂, LiNi_{0.5}Mn_{0.5}O₂, NMC111, NMC523, NMC622, NMC 721, NMC811, NCA). Spinel cathodes comprise one or more lithium-based positive electroactive materials selected from LiMn₂O₄ and LiNi_{0.5}Mn_{1.5}O₄. Olivine type cathodes comprise one or more lithium-based positive electroactive materials such as LiV₂(PO₄)₃, LiFePO₄, LiCoPO₄, and LiMnPO₄. Tavorite type cathodes comprise, for example, LiVPO₄F. Borate type cathodes comprise, for example, one or more of LiFeBO₃, LiCoBO₃, and LiMnBO₃. Silicate type cathodes comprise, for example, Li₂FeSiO₄, Li₂MnSiO₄, and LiMnSiO₄F. In still further variations, the positive electrode 24 may comprise one or more other positive electroactive materials, such as one or more of dilithium (2,5-dilithiooxy)terephthalate and polyimide. In various aspects, the positive electroactive material may be optionally coated (for example by LiNbO₃ and/or Al₂O₃) and/or may be doped (for example by one or more of magnesium (Mg), aluminum (Al), and manganese (Mn)).

The positive electroactive material of the positive electrode 24 may be optionally intermingled with one or more electrically conductive materials that provide an electron conductive path and/or at least one polymeric binder material that improves the structural integrity of the positive electrode 24. For example, the positive electroactive material in the positive electrode 24 may be optionally intermingled with binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

For example, the positive electrode 24 may include greater than or equal to about 50 wt. % to less than or equal to about 99 wt. %, and in certain aspects, optionally greater than or equal to about 50 wt. % to less than or equal to about 95 wt. %, of the positive electroactive material; greater than or equal to about 0 wt. % to less than or equal to about 30 wt. %, and in certain aspects, optionally greater than or equal to about 2 wt. % to less than or equal to about 5 wt. %, of one or more electrically conductive materials; and greater than or equal to about 0 wt. % to less than or equal to about 20 wt. %, and in certain aspects, optionally greater than or equal to about 2 wt. % to less than or equal to about 5 wt. %, of one or more binders.

### EXAMPLES

Embodiments and features of the present technology are further illustrated through the following non-limiting examples:

### Example I—Lithium Bis(Fluorosulfonyl)Imide as an Electrolyte Salt

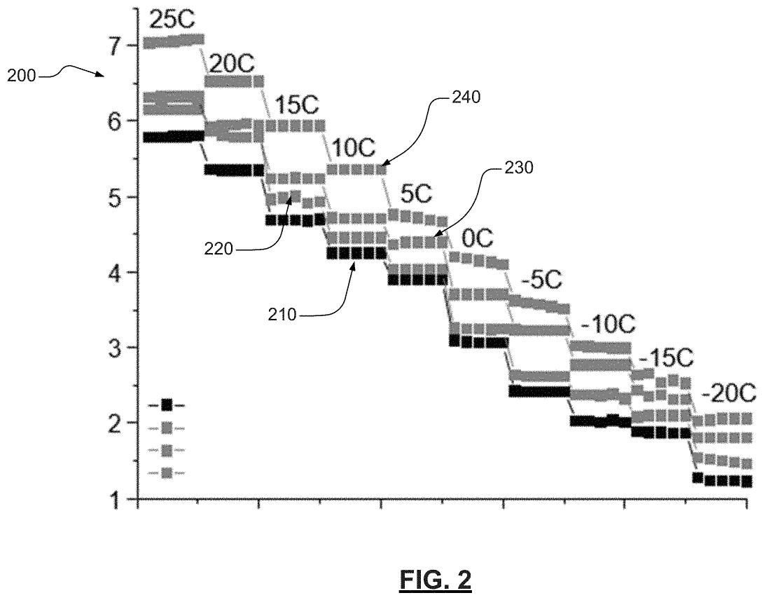

As illustrated in FIG. 2, the conductivity (mS/cm) of example electrochemical cells having different electrolyte systems may be compared, for example at temperatures between −20° C. and 25° C. The y-axis 200 in FIG. 2 represents conductivity (mS/cm).

A first example electrochemical cell 210 may include a first electrolyte system. The first electrolyte system may include 1.2 M of the lithium salt lithium hexafluorophosphate (LiPF₆) and co-solvents ethylene carbonate (EC) and ethyl methyl carbonate (EMC) having a volumetric ratio of about 3:7.

A second example electrochemical cell 220 may include a second electrolyte system. The second electrolyte system may include 0.8 M of the lithium salt lithium hexafluorophosphate (LiPF₆) and co-solvents ethylene carbonate (EC) and ethyl methyl carbonate (EMC) having a volumetric ratio of about 3:7.

A third example electrochemical cell 230 may include a third electrolyte system. The third electrolyte system may include 0.4 M of the lithium salt lithium hexafluorophosphate (LiPF₆) and 0.8 M of the lithium salt lithium fluorosulfonylimide (LiN(FSO₂)₂) (LiFSI) and co-solvents ethylene carbonate (EC) and ethyl methyl carbonate (EMC) having a volumetric ratio of about 3:7.

A fourth example electrochemical cell 240 may include a fourth electrolyte system. The fourth electrolyte system may include 1.2 M of the lithium salt lithium fluorosulfonylimide (LiN(FSO₂)₂) (LiFSI) and co-solvents ethylene carbonate (EC) and ethyl methyl carbonate (EMC) having a volumetric ratio of about 3:7.

As illustrated in FIG. 2, example electrochemical cells 210, 220, 230, 240 including electrolytes having increased amounts of lithium fluorosulfonylimide (LiN(FSO₂)₂) (LiFSI) may have increased conductivity. For example, the third example electrochemical cell 230 including 0.4 M of the lithium salt lithium hexafluorophosphate (LiPF₆) and 0.8 M of the lithium salt lithium fluorosulfonylimide (LiN(FSO₂)₂) (LiFSI) has superior conductivity as compared to the first and second electrochemical cells 210, 220, which include only the lithium salt lithium hexafluorophosphate (LiPF₆). Further, the fourth example electrochemical cell 240 including 1.2 M of the lithium salt lithium fluorosulfonylimide (LiN(FSO₂)₂) (LiFSI) has superior conductivity as compared to the first and second electrochemical cells 210, 220, as well as the third electrochemical cell 230.

### Example II—Lithium Bis(Fluorosulfonyl)Imide Amounts and Performance

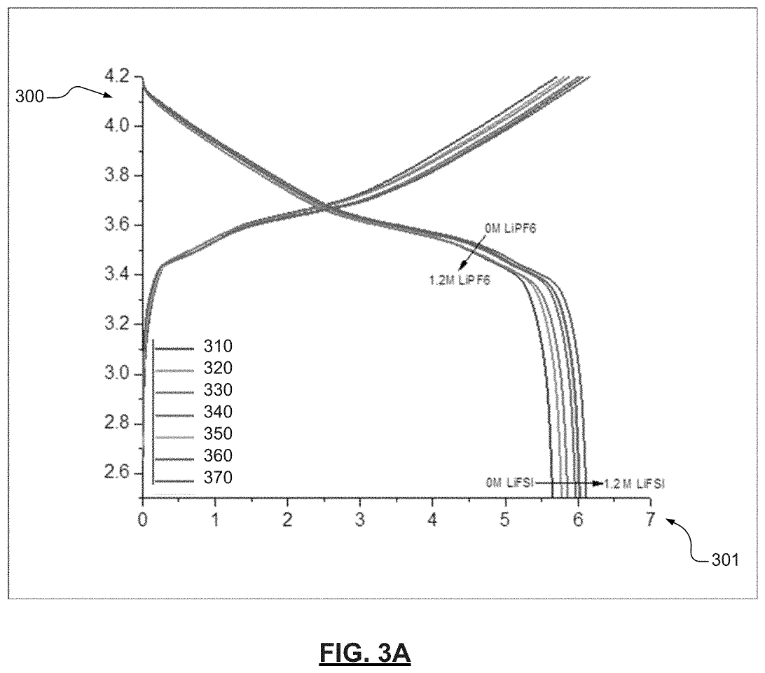

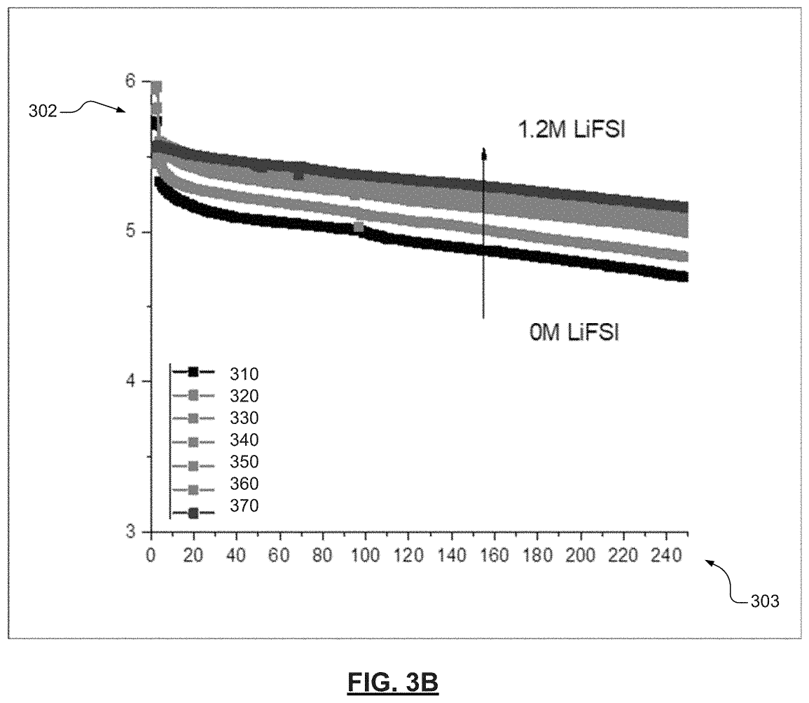

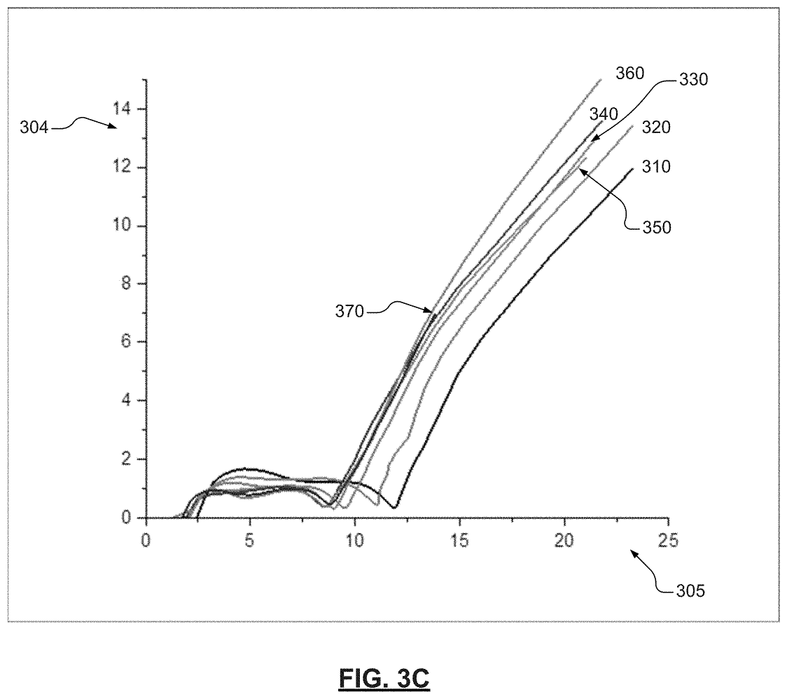

As illustrated in FIGS. 3A and 3B, the cycle performance of example electrochemical cells having different electrolyte systems may be compared. For example, in FIG. 3A, the y-axis 300 represents voltage (V) and the x-axis 301 represents capacity (mAh). In FIG. 3B, the y-axis 302 represents discharge capacity (mAh) and the x-axis 303 represents cycle number. As illustrated in FIG. 3C, the electrochemical impedance the example electrochemical cells having the different electrolyte systems may be compared, for example electrochemical impedance spectroscopy (“EIS”). In FIG. 3C, the y-axis 304 represents—Im(Z)/Ohm and the x-axis 305 represents Re(Z) Ohm.

A first example electrochemical cell 310 may include a first electrolyte system. The first electrolyte system may include 1.2 M of the lithium salt lithium hexafluorophosphate (LiPF₆) and co-solvents ethylene carbonate (EC) and ethyl methyl carbonate (EMC) having a volumetric ratio of about 3:7.

A second example electrochemical cell 320 may include a second electrolyte system. The second electrolyte system may include 1.0 M of the lithium salt lithium hexafluorophosphate (LiPF₆) and 0.2 M of the lithium salt lithium fluorosulfonylimide (LiN(FSO₂)₂) (LiFSI) and co-solvents ethylene carbonate (EC) and ethyl methyl carbonate (EMC) having a volumetric ratio of about 3:7.

A third example electrochemical cell 330 may include a third electrolyte system. The third electrolyte system may include 0.8 M of the lithium salt lithium hexafluorophosphate (LiPF₆) and 0.4 M of the lithium salt lithium fluorosulfonylimide (LiN(FSO₂)₂) (LiFSI) and co-solvents ethylene carbonate (EC) and ethyl methyl carbonate (EMC) having a volumetric ratio of about 3:7.

A fourth example electrochemical cell 340 may include a fourth electrolyte system. The fourth electrolyte system may include 0.6 M of the lithium salt lithium hexafluorophosphate (LiPF₆) and 0.6 M of the lithium salt lithium fluorosulfonylimide (LiN(FSO₂)₂) (LiFSI) and co-solvents ethylene carbonate (EC) and ethyl methyl carbonate (EMC) having a volumetric ratio of about 3:7.

A fifth example electrochemical cell 350 may include a fifth electrolyte system. The fifth electrolyte system may include 0.4 M of the lithium salt lithium hexafluorophosphate (LiPF₆) and 0.8 M of the lithium salt lithium fluorosulfonylimide (LiN(FSO₂)₂) (LiFSI) and co-solvents ethylene carbonate (EC) and ethyl methyl carbonate (EMC) having a volumetric ratio of about 3:7.

A sixth example electrochemical cell 360 may include sixth electrolyte system. The sixth electrolyte system may include 0.2 M of the lithium salt lithium hexafluorophosphate (LiPF₆) and 1.0 M of the lithium salt lithium fluorosulfonylimide (LiN(FSO₂)₂) (LiFSI) and co-solvents ethylene carbonate (EC) and ethyl methyl carbonate (EMC) having a volumetric ratio of about 3:7.

A seventh example electrochemical cell 370 may include seventh electrolyte system. The seventh electrolyte system may 1.2 M of the lithium salt lithium fluorosulfonylimide (LiN(FSO₂)₂) (LiFSI) and co-solvents ethylene carbonate (EC) and ethyl methyl carbonate (EMC) having a volumetric ratio of about 3:7.

As illustrated in FIGS. 3A-3C, example electrochemical cells 310, 320, 330, 340, 350, 360, 370 including electrolytes having increased amounts of lithium fluorosulfonylimide (LiN(FSO₂)₂) (LiFSI) may have improved stability and long-term performance. Further, as illustrated in FIG. 3B, electrochemical cell 370 has superior capacity delivery and retention. For example, as illustrated, electrochemical cell 370 has the highest capacity delivery of about 6.25 mAh and the best capacity retention of about 95% after about 250 cycles, while electrochemical cell 310 has the lowest capacity delivery of about 5.73 mAh and the worse capacity retention of about 88% after about 250 cycles. Further still, as illustrated in FIG. 3C, example electrochemical cells 310, 320, 330, 340, 350, 360, 370 including electrolytes having increased amounts of lithium fluorosulfonylimide (LiN(FSO₂)₂) (LiFSI) may have reduced impedance over time. For example, electrochemical cell 370 has the lowest interfacial impedance of about 2.5 Ohm and resistance of charge transfer of about 3.4 Ohm, while electrochemical cell 310 has the highest interfacial impedance of about 3.6 Ohm and resistance of charge transfer of about 7.63 Ohm.

More specifically, as summarized in Table 1 below, electrolytes having increased amounts of lithium fluorosulfonylimide (LiN(FSO₂)₂) (LiFSI) (and reduced amounts of lithium hexafluorophosphate (LiPF₆)) may have improved capacity retention.

| | | 250^{th} | Capacity |
|---|---|---|---|
| | | Capacity | Retention |
| Electrolyte | | (mAh/g) | (250 cycles) |
| 310 | 1.2M LiPF₆ in EC/EMC | 144 | 87.2% |
| 320 | 1.0M LiPF₆ + 0.2M LiFSI in EC/EMC | 148 | 88.0% |
| 330 | 0.8M LiPF₆ + 0.4M LiFSI in EC/EMC | 153 | 91.4% |
| 340 | 0.6M LiPF₆ + 0.6M LiFSI in EC/EMC | 155 | 91.8% |
| 350 | 0.4M LiPF₆ + 0.8M LiFSI in EC/EMC | 156 | 92.2% |
| 360 | 0.2M LiPF₆ + 1.0M LiFSI in EC/EMC | 157 | 92.4% |
| 370 | 1.2M LiFSI in EC/EMC | 160 | 92.9% |

### Example III—Corrosion Resistance Using Solvent Selection

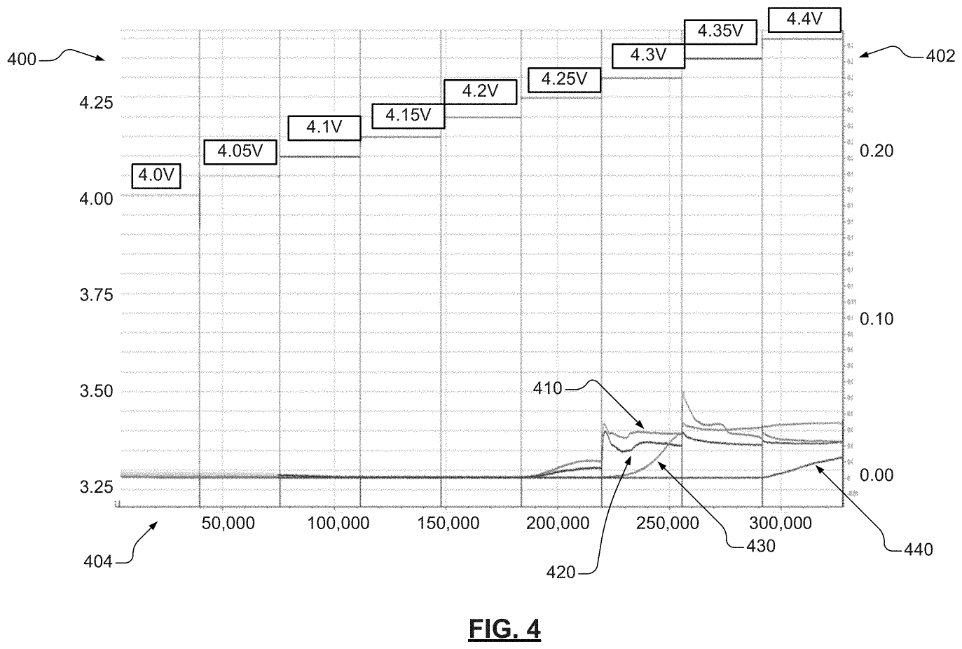

As illustrated in FIG. 4, the leakage current of aluminum working electrodes under different cutoff voltage of example electrochemical cells having different electrolyte systems may be compared. High leakage current suggests or indicates aluminum corrosion. For example, in FIG. 4, the y₁-axis 400 represents cutoff voltage and y₂-axis 402 represents leakage current, while the x-axis 404 represents time/s.

A first example electrochemical cell 410 may include a first electrolyte system. The first electrolyte system may include 1.2 M of the lithium salt lithium fluorosulfonylimide (LiN(FSO₂)₂) (LiFSI) and co-solvents ethyl methyl carbonate (EMC) and ethylene carbonate (EC) having a volumetric ratio of about 5:5.

A second example electrochemical cell 420 may include a second electrolyte system. The second electrolyte system may include 1.2 M of the lithium salt lithium fluorosulfonylimide (LiN(FSO₂)₂) (LiFSI) and co-solvents ethyl methyl carbonate (EMC) and ethylene carbonate (EC) having a volumetric ratio of about 7:3.

A third example electrochemical cell 430 may include a third electrolyte system. The third electrolyte system may include 1.2 M of the lithium salt lithium fluorosulfonylimide (LiN(FSO₂)₂) (LiFSI) and co-solvents ethyl methyl carbonate (EMC) and ethylene carbonate (EC) having a volumetric ratio of about 9:1.

A fourth example electrochemical cell 440 may include a fourth electrolyte system. The fourth electrolyte system may include 1.2 M of the lithium salt lithium fluorosulfonylimide (LiN(FSO₂)₂) (LiFSI) and solvent ethyl methyl carbonate (EMC).

As illustrated in FIG. 4, example electrochemical cells 410, 420, 430, 440 including electrolytes having reduced amounts of solvent ethylene carbonate (EC) may have improved long-term performance. For example, the third example electrochemical cell 430 including co-solvents ethyl methyl carbonate (EMC) and ethylene carbonate (EC) having a volumetric ratio of about 9:1 has superior performance as compared to the first and second electrochemical cells 410, 420, which include greater amounts of the co-solvent ethylene carbonate (EC). Further, the fourth example electrochemical cell 440 including no ethylene carbonate (EC) has superior performance as compared to the first and second electrochemical cells 410, 420, as well as the third electrochemical cell 430. For example, as illustrated, aluminum corrosion voltage limit may increase from about 4.25 V to about 4.4 V when ethylene carbonate (EC) is reduced or removed.

### Example IV—Corrosion Resistance Using Electrolyte Additives

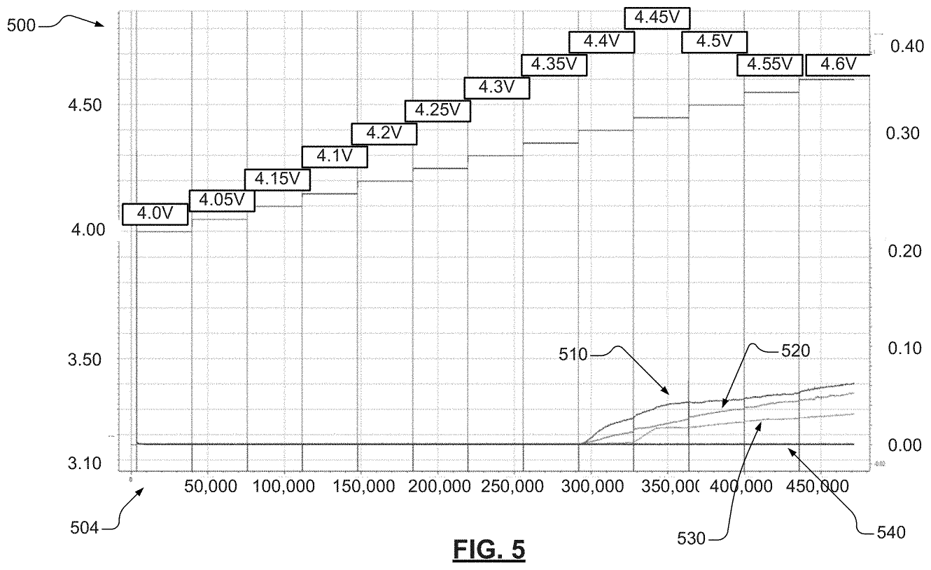

FIG. 5 also illustrates the leakage current of aluminum working electrodes under different cutoff voltage of comparative electrochemical cells having different electrolyte systems. As noted above, High leakage current suggests or indicates aluminum corrosion. For example, in FIG. 5, the y₁-axis 500 represents upper cutoff voltage and y₂-axis 502 represents leakage current, while the x-axis 504 represents time/s.

A first example electrochemical cell 510 may include a first electrolyte system. The first electrolyte system may include 1.2 M of the lithium salt lithium fluorosulfonylimide (LiN(FSO₂)₂) (LiFSI) and solvent ethyl methyl carbonate (EMC).

A second example electrochemical cell 520 may include a second electrolyte system. The second electrolyte system may include 1.2 M of the lithium salt lithium fluorosulfonylimide (LiN(FSO₂)₂) (LiFSI) and solvent ethyl methyl carbonate (EMC). The second electrolyte system may also include 1 wt. % lithium 2-trifluoromethyl-4,5-dicyanoimidazolide (LiTDI).

A third example electrochemical cell 530 may include a third electrolyte system. The third electrolyte system may include 1.2 M of the lithium salt lithium fluorosulfonylimide (LiN(FSO₂)₂) (LiFSI) and solvent ethyl methyl carbonate (EMC). The third electrolyte system may also include 1 wt. % lithium difluoro(oxalato)borat (LiDFOB).

A fourth example electrochemical cell 540 may include a fourth electrolyte system. The fourth electrolyte system may include 1.2 M of the lithium salt lithium fluorosulfonylimide (LiN(FSO₂)₂) (LiFSI) and solvent ethyl methyl carbonate (EMC). The fourth electrolyte system may also include 1 wt. % lithium bis(oxalato)boarate (LiBOB).

As illustrated in FIG. 5, example electrochemical cells 510, 520, 530, 540 including electrolytes having reduced amounts of solvent ethylene carbonate (EC) and different additives may experience reduced Al corrosion leakage current and improved long-term performance. For example, example cells including 1 wt. % lithium bis(oxalato)boarate (LiBOB), such as in the fourth example electrochemical cell 540, may have an improved aluminum corrosion voltage limitation of about 4.6 V.

### Example V—Solid Electrolyte Interface (SEI) Formation Using Electrolyte Additives

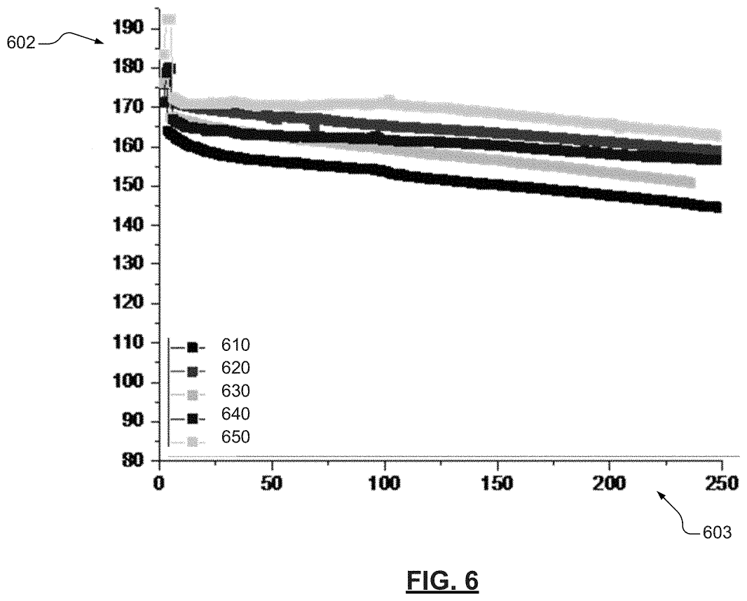

As illustrated in FIG. 6, the cycle performance of example electrochemical cells having different electrolyte systems may be compared. In FIG. 6, the y-axis 602 represents capacity (mAh/g) and the x-axis 603 represents cycle number.

A first example electrochemical cell 610 may include a first electrolyte system. The first electrolyte system may include 1.2 M of the lithium salt lithium hexafluorophosphate (LiPF₆) and co-solvents ethylene carbonate (EC) and ethyl methyl carbonate (EMC) having a volumetric ratio of about 3:7.

A second example electrochemical cell 620 may include a second electrolyte system. The second electrolyte system may include 1.2 M of the lithium salt lithium fluorosulfonylimide (LiN(FSO₂)₂) (LiFSI) and co-solvents ethylene carbonate (EC) and ethyl methyl carbonate (EMC) having a volumetric ratio of about 3:7.

A third example electrochemical cell 630 may include a third electrolyte system. The third electrolyte system may include 1.2 M the lithium salt lithium fluorosulfonylimide (LiN(FSO₂)₂) (LiFSI) and solvent ethyl methyl carbonate (EMC). The third electrolyte system may further include one or more electrolyte additives. For example, the third electrolyte may further include about 5 wt. % of bis(trifluoroethyl) carbonate (DFEC) and about 1 wt. % of lithium difluoro(oxalato)borat (LiDFOB).

A fourth example electrochemical cell 640 may include a fourth electrolyte system. The fourth electrolyte system may include 1.2 M of the lithium salt lithium fluorosulfonylimide (LiN(FSO₂)₂) (LiFSI) and solvent ethyl methyl carbonate (EMC). The fourth electrolyte system may further include one or more electrolyte additives. For example, the fourth electrolyte may further include about 5 wt. % of fluoroethylene carbonate (FEC) and about 1 wt. % of lithium difluoro(oxalato)borat (LiDFOB).

A fifth example electrochemical cell 650 may include a fifth electrolyte system. The fifth electrolyte system may include 1.2 M of the lithium salt lithium fluorosulfonylimide (LiN(FSO₂)₂) (LiFSI) and solvent ethyl methyl carbonate (EMC). The fifth electrolyte system may further include one or more electrolyte additives. For example, the fifth electrolyte system may further include about 5 wt. % of fluoroethylene carbonate (FEC), about 2 wt. % vinylene carbonate (VC), about 1 wt. % of ethylene sulfate (DTD), and about 1 wt. % of lithium difluoro(oxalato)borat (LiDFOB).

As illustrated in FIG. 6, example electrochemical cells 610, 620, 630, 640, 650 including electrolytes having different electrolyte additives may have improved long-term performance. For example, the third example electrochemical cell 630 free of ethylene carbonate (EC) and including electrolyte additives lithium difluoro(oxalato)borat (LiDFOB) and bis(trifluoroethyl) carbonate (DFEC) has superior capacity and capacity retention as compared to the first and second electrochemical cells 610, 620, which include co-solvent ethylene carbonate (EC). Further, the fourth example electrochemical cell 640 including no ethylene carbonate (EC) and electrolyte additives lithium difluoro(oxalato)borat (LiDFOB) and fluoroethylene carbonate (FEC) has superior conductivity as compared to the first and second electrochemical cells 610, 620, as well as the third electrochemical cell 630. Further still, the fifth example electrochemical cell 650 including no ethylene carbonate (EC) and electrolyte additives of fluoroethylene carbonate (FEC), vinylene carbonate (VC), ethylene sulfate (DTD), and lithium difluoro(oxalato)borat (LiDFOB), has superior conductivity as compared to the first and second electrochemical cells 610, 620, as well as the third and fourth electrochemical cells 630, 640.

More specifically, as summarized in Table 2 below, electrolytes comprising lithium fluorosulfonylimide (LiN(FSO₂)₂) (LiFSI) (and reduced amounts of lithium hexafluorophosphate (LiPF₆)) and one or more additives may have improved capacity retention.

| | | | Capacity |
|---|---|---|---|
| | | 250^{th} Capacity | Retention |
| Electrolyte | | (mAh/g) | (250 cycles) |
| 610 | 1.2M LiPF₆ in EC/EMC | 144 | 87.2% |
| 620 | 1.2M LiFSI in EC/EMC | 160 | 92.9% |
| 630 | 1.2M LiFSI in EMC + 5 wt. % | 150 | 93.2% |
| | DFEC + 1 wt. % LiDFOB | | |
| 640 | 1.2M LiFSI in EMC + 5 wt. % | 157 | 94.2% |
| | FEC + 1 wt. % LiDFOB | | |
| 650 | 1.2M LiFSI in EMC + 5 wt. % | 163 | 95.0% |
| | FEC + 2 wt. % CV + 1 wt. % | | |
| | DTD + 1 wt. % LiDFOB | | |

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrolyte system for a graphite-containing electrode, the electrolyte system comprising:
greater than or equal to about 1.0 M to less than or equal to about 1.5 M of lithium fluorosulfonylimide (LiN(FSO₂)₂) (LiFSI);
less than or equal to about 0.5 M of lithium hexafluorophosphate (LiPF₆); and
one or more solvents comprising ethylene carbonate (EC), wherein electrolyte system comprises less than or equal to about 30 wt. % of ethylene carbonate (EC).

2. The electrolyte system of claim 1, wherein the electrolyte system further comprises one or more corrosion-resistant additives selected from the group consisting of: lithium difluoro(oxalato)borat (LiDFOB), lithium bis(oxalato)boarate (LiBOB), lithium 2-trifluoromethyl-4,5-dicyanoimidazolide (LiTDI), lithium perchlorate (LiClO₄), lithium hexafluorophosphate (LiPF₆), lithium tetrafluoroborate (LiBF₄), and combinations thereof.

3. The electrolyte system of claim 2, wherein the electrolyte system comprises greater than or equal to about 1 wt. % to less than or equal to about 5 wt. % of the one or more corrosion-resistant additives.

4. The electrolyte system of claim 1, wherein the electrolyte system further comprises one or more formation additives selected from the group consisting of: fluoroethylene carbonate (FEC), bis(trifluoroethyl) carbonate (DFEC), trifluoropropylene carbonate (TFPC), vinylene carbonate (VC), ethylene sulfate (DTD), 1,3-propene sultone (PES), 1,3-propane sultone (PS), and combinations thereof, wherein the one or more formation additives assist in the formation of a solid electrolyte interface layer on one or more surfaces of the graphite-containing electrode.

5. The electrolyte system of claim 4, wherein the electrolyte system comprises less than or equal to about 10 wt. % of the one or more formation additives.

6. The electrolyte system of claim 1, wherein the electrolyte system further comprises one or more stabilizer additives selected from the group consisting of: 1,3,2-dioxathiolane 2,2-dioxide, 1,2-oxathiolane 2,2-dioxide, tetrahydrothiophene 1,1-dioxide, and combinations thereof.

7. The electrolyte system of claim 6, wherein the electrolyte system comprises less than or equal to about 5 wt. % of the one or more stabilizer additives.

8. The electrolyte system of claim 1, wherein the graphite-containing electrode has a loading density of greater than or equal to about 4.0 mAh/cm².

9. A high-energy density electrochemical cell that cycles lithium ions comprising:
an electrode comprising a graphite-containing electroactive material and having a loading density of greater than or equal to about 4.0 mAh/cm²; and
an electrolyte comprising:
greater than or equal to about 1.0 M to less than or equal to about 1.5 M of lithium fluorosulfonylimide (LiN(FSO₂)₂) (LiFSI);
less than or equal to about 0.5 M of lithium hexafluorophosphate (LiPF₆); and
one or more solvents comprising ethylene carbonate (EC), wherein the electrolyte comprises less than or equal to about 30 wt. % of ethylene carbonate (EC).

10. The electrochemical cell of claim 9, wherein the electrolyte further comprises one or more corrosion-resistant additives selected from the group consisting of: lithium difluoro(oxalato)borat (LiDFOB), lithium bis(oxalato)boarate (LiBOB), lithium 2-trifluoromethyl-4,5-dicyanoimidazolide (LiTDI), lithium perchlorate (LiClO₄), lithium hexafluorophosphate (LiPF₆), lithium tetrafluoroborate (LiBF₄), and combinations thereof.

11. The electrochemical cell of claim 10, wherein the electrolyte comprises greater than or equal to about 1 wt. % to less than or equal to about 5 wt. % of the one or more corrosion-resistant additives.

12. The electrochemical cell of claim 9, wherein the electrolyte further comprises one or more formation additives selected from the group consisting of: fluoroethylene carbonate (FEC), bis(trifluoroethyl) carbonate (DFEC), trifluoropropylene carbonate (TFPC), vinylene carbonate (VC), ethylene sulfate (DTD), 1,3-propene sultone (PES), 1,3-propane sultone (PS), and combinations thereof, wherein the one or more formation additives assist in the formation of a solid electrolyte interface layer on one or more surfaces of the graphite-containing electrode.

13. The electrochemical cell of claim 12, wherein the electrolyte comprises less than or equal to about 10 wt. % of the one or more formation additives.

14. The electrochemical cell of claim 9, wherein the electrolyte further comprises one or more stabilizer additives selected from the group consisting of: 1,3,2-dioxathiolane 2,2-dioxide, 1,2-oxathiolane 2,2-dioxide, tetrahydrothiophene 1,1-dioxide, and combinations thereof.

15. The electrochemical cell of claim 14, wherein the electrolyte comprises less than or equal to about 2 wt. % of the one or more stabilizer additives.

16. A high-energy density electrochemical cell that cycles lithium ions comprising:
an electrode comprising a graphite-containing electroactive material and having a loading density of greater than or equal to about 4.0 mAh/cm²; and
an electrolyte comprising:
greater than or equal to about 1.0 M to less than or equal to about 1.5 M of lithium fluorosulfonylimide (LiN(FSO₂)₂) (LiFSI); and
one or more electrolyte additives selected from the group consisting of: lithium difluoro(oxalato)borat (LiDFOB), lithium bis(oxalato)boarate (LiBOB), lithium 2-trifluoromethyl-4,5-dicyanoimidazolide (LiTDI), fluoroethylene carbonate (FEC); bis(trifluoroethyl) carbonate (DFEC); trifluoropropylene carbonate (TFPC); vinylene carbonate (VC); ethylene sulfate (DTD); 1,3-propene sultone (PES); 1,3-propane sultone (PS); 1,3,2-dioxathiolane 2,2-dioxide; 1,2-oxathiolane 2,2-dioxide; tetrahydrothiophene 1,1-dioxide; and combinations thereof.

17. The electrochemical cell of claim 16, wherein the electrolyte further comprises:
greater than 0 M to less than or equal to about 0.5 M of lithium hexafluorophosphate (LiPF₆); and
one or more solvents comprising ethylene carbonate (EC), wherein electrolyte comprises less than or equal to about 30 wt. % of ethylene carbonate (EC).

18. The electrochemical cell of claim 16, wherein the electrolyte comprises greater than or equal to about 1 wt. % to less than or equal to about 5 wt. % of the one or more electrolyte additives selected from the group consisting of: lithium difluoro(oxalato)borat (LiDFOB), lithium bis(oxalato)boarate (LiBOB), lithium 2-trifluoromethyl-4,5-dicyanoimidazolide (LiTDI), lithium perchlorate (LiClO₄), lithium hexafluorophosphate (LiPF₆), lithium tetrafluoroborate (LiBF₄), and combinations thereof.

19. The electrochemical cell of claim 16, wherein the electrolyte comprises greater than 0 wt. % to less than or equal to about 10 wt. % of the one or more electrolyte additives selected from the group consisting of: fluoroethylene carbonate (FEC), bis(trifluoroethyl) carbonate (DFEC), trifluoropropylene carbonate (TFPC), vinylene carbonate (VC), ethylene sulfate (DTD), 1,3-propene sultone (PES), 1,3-propane sultone (PS), and combinations thereof.

20. The electrochemical cell of claim 16, wherein the electrolyte comprises greater than 0 wt. % to less than or equal to about 2 wt. % of the one or more electrolyte additives selected from the group consisting of: 1,3,2-dioxathiolane 2,2-dioxide, 1,2-oxathiolane 2,2-dioxide, tetrahydrothiophene 1,1-dioxide, and combinations thereof.
